(19) United States
(12) Patent Application Publication
(10) Pub. No.: US 2009/0017881 A1
(43) Pub. Date: Jan. 15, 2009

(54) Storage and activation of mobile phone components

(76) Inventor: David Madrigal, Houston, TX (US)

Correspondence Address: LAW OFFICE OF DAVID MCEWING, P.O. BOX 231324, HOUSTON, TX, 77023, US

(21) Appl. No.: 11/827,036

(22) Filed: Jul. 10, 2007

(51) Int. Cl. H04M 1/02

(52) U.S. Cl. 455/575.1

(57) ABSTRACT

The specification relates generally to mobile phones used in conjunction with wireless earpieces containing a microphone and audio component. The specification discloses a mobile phone comprising an earpiece removeably attached to the mobile phone and a removable protective cover and the earpiece is activated on by removal of the earpiece from the phone. The mobile phone includes a docking component to hold detachably hold the earpiece. The docking component can include electric contacts for charging the battery of the earpiece from the phone battery. The mobile phone can include a storage space dimensioned to hold earpieces of different sizes.

### BACKGROUND OF INVENTION

1. Field of Use

The device and method subject of this disclosure pertains to improving the efficiency of mobile phones used in conjunction with wireless components such as microphones and audio components.

2. Related Art

Mobile phones are known and are of increasing popularity. They are now viewed as a necessity by many people. Mobile phone users are being encouraged to use the phones in a “hands free” mode, particularly when operating a car. In deed this is required by the law in many locations. What this means is that the user wears an ear piece that allow him/her to hear the telephone conversation and a microphone to speak and participate in the telephone conversation without having to use a hand to hold a mobile phone to the user's ear.

What has become increasingly popular are Bluetooth wireless ear pieces and microphones that are operated in conjunction with the user's mobile phone. Other wireless technologies are available. For example there are wireless USB ports, ZigBee, UWB and Wi-Fi networks. These and other technologies are within the scope of this invention. Hands free use is encouraged without wires between the user's ear and the mobile phone.

Utilization or activation of a wireless earpiece device, e.g., Bluetooth, can be time consuming or cumbersome. For example, to activate a Bluetooth unit used with a Blackberry 7100, the user has to use the following procedure:
a. Start with the Blackberry Main Screen;
b. Scroll to settings and select “Options”;
c. Scroll to Bluetooth and select;
d. Look for Bluetooth device in “Paired Devices” and select if it has been paired already, if not follow the next steps;
e. Click once on the scroll button;
f. A menu will appear with several options, select “Add Device”;
g. The phone will search for a new Bluetooth device and will notify user if it finds or doesn't find a new device.
h. If the search finds the user's Bluetooth it will ask the user to confirm if he/she wants to add to pair devices and then the user should see it in the list of pair devices and the user will be able to select it.
i. If the search for new Bluetooth earpiece devices does not show the device, the user can select to Search again and again. If that does not work the user must “play” with the Bluetooth device until it sends a signal to be picked up by the mobile phone. This process can take several minutes or hours and can become very frustrating.
j. Once the phone has been paired, to the Bluetooth earpiece, the phone might pick-up the Bluetooth earpiece when it is turned on. This might or might not happen depending on how close the phone is to the Bluetooth Earpiece, interference, etc.
k. To deactivate the Bluetooth Device, the user must go through the same process except for pairing the device.

To activate a Bluetooth device in a Samsung D807 the user needs to go through the following steps.
a. Start in Main Screen;
b. Go to “Settings”;
c. Scroll down to the “Bluetooth Menu”;
d. From Bluetooth Menu select “Turn Bluetooth On”;
e. Once Bluetooth is On, go to “My Devices”;
f. The user must look at the Bluetooth devices in My Devices and select his/her devices, if it has been paired already. If the device has not been pair, the user must follow the next steps;
g. Select the Search New Device;
h. The phone will search for new Bluetooth devices and will notify the user if it finds or doesn't find new devices;
i. If the search finds the user's Bluetooth it will ask the user to confirm the addition of the pair-devices and then user should see it in the list of pair devices and the user will be able to select it.
j. If the search for new Bluetooth devices does not show user's device, the user can select to Search again and again. If that does not work, the user must “play” with the Bluetooth device until it sends a signal to be picked up by the mobile phones. This process can take several minutes or hours and can get very frustrating.
k. Once the phone has been paired the Bluetooth earpiece, the phone might pick-up the Bluetooth earpiece when is turned on. This might or might not happen depending on how close the phone is to the Bluetooth Earpiece, interference, etc.
l. To deactivate the Bluetooth device the user must go through the same process except for pairing the device.

The above listing of steps are merely examples. Other mobile phones have the same issues to greater or lesser extent.

The term Bluetooth is used herein for equipment meeting the specifications of Bluetooth Special Interest Group (SIG) or IEEE 802.15.1.

There is currently significant time and attention required to activate a wireless device for use with a mobile phone. This discourages the use of these devices, particularly when the user is using a mobile phone while driving. It would be desirable to have a method and device for quickly activating wireless components to a mobile phone.

The existing technology is also scaling down the size and weight of mobile phone ear pieces. This includes both microphones and audio components. While this is a positive development, it is also causing increased instances of lost or damaged components. It would be desirable to have a convenient and secure location for storing these components.

### SUMMARY OF INVENTION

The device subject of this disclosure includes a wireless microphone and audio device (earpiece) stored with a mobile device, e.g., mobile phone, and activated when detached from the phone. The earpiece fits to a holder component on a mobile phone case. There may be electrical components establishing electrical communication between the mobile phone and the stored wireless earpiece for charging the wireless microphone and audio device. A switch mechanism may be activated by removal of the wireless microphone and audio device from the cell phone holder component. The earpiece is activated by the switch. The wireless microphone and audio device system is deactivated by returning the earpiece to a storage holder on the mobile phone case.

### SUMMARY OF DRAWINGS

The accompanying drawings, which are incorporated in and constitute a part of the specification, illustrate embodiments of the invention. These drawings, together with the general description of the invention given above and the detailed description of the embodiments, i.e., examples, given below, serve to explain the principles of the invention.

FIG. 1 illustrates a front view of a generic mobile phone

FIG. 2 illustrates a side view of a mobile phone containing a storage compartment for a wireless earpiece.

FIG. 3 illustrates back view of the mobile phone wherein the earpiece storage compartment is shown by phantom lines.

FIG. 4 illustrates the front view of the mobile phone illustrating a wireless earpiece docked to the charger of the mobile phone.

FIG. 5 illustrates a side perspective of the mobile with the wireless earpiece.

FIG. 6 illustrates a back view of the mobile phone case with the stored wireless earpiece.

FIG. 7 illustrates the inner portion of the earpiece storage compartment, including a cradle with an electronic power charger and docking cradle (holder component).

FIG. 8 is a top view of a mobile phone with attached wireless earpiece.

FIG. 9 illustrates a bottom view of the mobile phone and attached wireless earpiece.

FIG. 10 illustrates an additional back view of the mobile phone with the wireless earpiece in a detached position. Also illustrated is the holder component. The earpiece storage compartment is shown in phantom lines.

FIG. 11 illustrates a top view of the mobile phone with the wireless earpiece in an attached position.

FIG. 12 illustrates the back side of the mobile phone with the attached wireless earphone. Also illustrated is the battery compartment

FIGS. 13 and 14 illustrate the mobile device with a detachable Bluetooth earpiece.

FIG. 15 illustrates the wireless direct connection between the mobile phone and earpiece.

FIG. 16 illustrates a Mobile Device and Wireless Earpiece Recognition and Synchronization.

FIG. 17 illustrates a state diagram of a link controller.

FIG. 18 illustrates an overview diagram for a connection setup.

### DETAILED DESCRIPTION OF INVENTION

While this apparatus disclosed herein is susceptible of embodiments in many different forms, there is shown in the drawings and will herein be described in detail embodiments with the understanding that the present disclosure is to be considered as an exemplification of the principles of the disclosure and these examples are not intended to limit its broad aspect. The above general description and the following detailed description are merely illustrative and additional modes, advantages and particulars will be readily suggested to those skilled in the art without departing from the spirit and scope of the invention.

In one embodiment, a component comprising a wireless microphone and audio component (hereinafter “wireless earpiece” or “earpiece”) are stored on or within the case of a mobile device. The microphone electronically amplifies and transmits the user's voice. The audio component amplifies and transmits sounds transmitted to the mobile device.

The mobile device, (hereinafter “mobile phone” or “mobile device”) may comprise a mobile phone or cellular phone, PDA (personal data assistant), watch, MP3/MP4 player, Laptop/mini-Laptop personal computing devices, etc.

The storage mechanism may be a portion of the exterior case molded to accept a subcomponent of the wireless earpiece. For example, many earpieces have a clip subcomponent that fits over the user's ear similar to eyeglasses. Such a curved and relatively slender subcomponent could be “snapped” into a complementary dimensioned portion of the mobile device housing, i.e., a snap holder.

In another embodiment, the mobile device case may utilize a flexible strap to fasten the earpiece to the case.

The configuration of the earpiece may facilitate a different subcomponent being used as the point of attachment to a mobile device case. For example, the extended portion holding the microphone may be more suitable for attachment to the mobile device case.

In yet another embodiment, the earpiece fits into a holder component (also termed “cradle component”) of the mobile device case. The holder component can include electrical contacts that communicate with the batteries of the earpiece. The interruption of this connection by removal of the earpiece can also activate the earpiece “on”. This interruption can also serve to activate components of the phone for searching for and pairing with the earpiece.

The holder component may also provide a protection function. The earpiece can be held in position relative to the mobile device case that desired subcomponents of the earpiece are less likely to be damaged during handling and transport.

The protective advantage may be particularly attractive for storage within the mobile phone case or housing.

In one embodiment of the invention, batteries within the wireless earpiece may be recharged while stored with the mobile device. In one embodiment, the wireless earpiece is recharged through the above mentioned electrical contacts using the mobile device charger connected to an AC circuit.

In one embodiment, the earpiece is activated “on” when removed or detached from the storage component of the mobile device case. The earpiece is similarly deactivated when reattached to the device case.

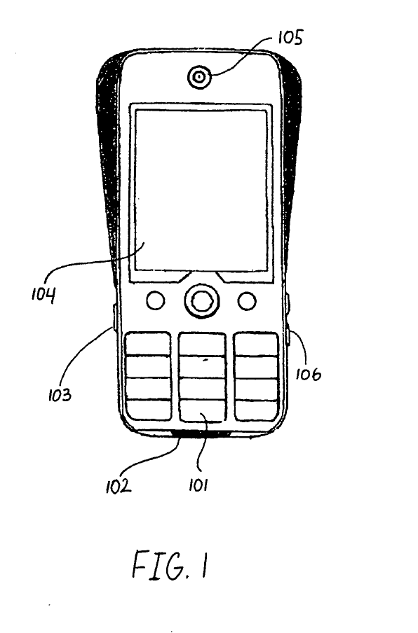

FIG. 1 illustrates the front of a common mobile phone. Illustrated are the phone keypad 101, electrical connections for recharging the phone battery 102, a power “on/off” switch 103, and LCD screen 104, a camera 105, and volume control buttons 106.

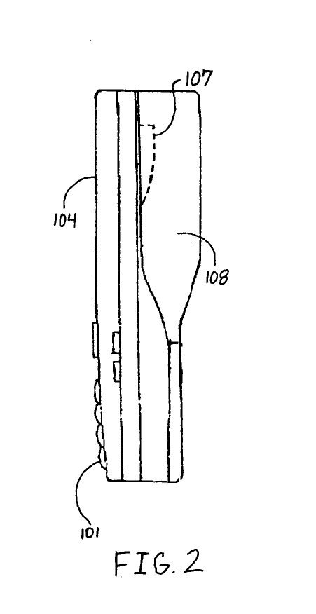

FIG. 2 illustrates a side view of the same phone. The location of the key pad 101 and LCD screen 104 are referenced as being on the front. Also illustrated is a cradle component 107 which may be used to hold the earpiece. The storage area 108 for the earpiece is also illustrated.

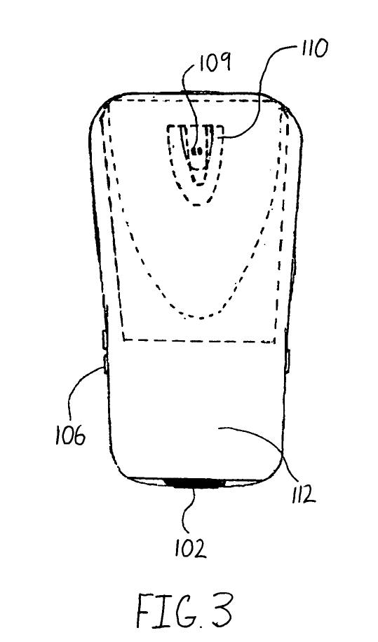

FIG. 3 illustrates the reverse or back side of the mobile phone. FIG. 3 depicts the volume control buttons 106, the electronic connectors 109 as part of the earpiece cradle 110, the removable storage cover 111, the mobile phone battery storage area 112 and the phone charger connectors 102.

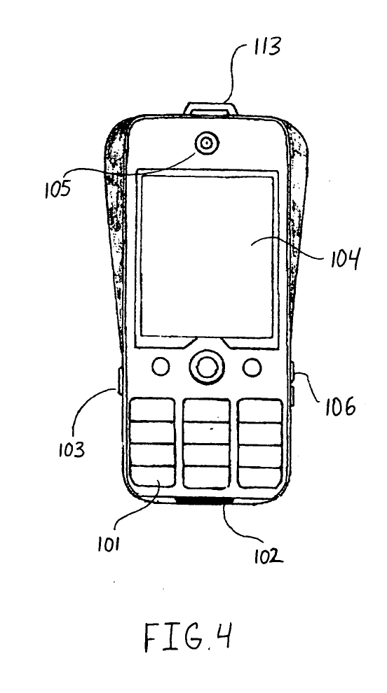

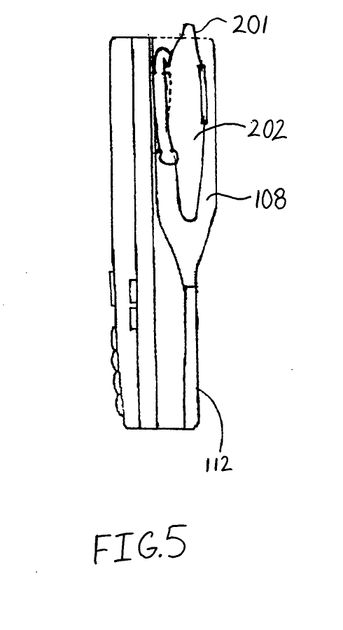

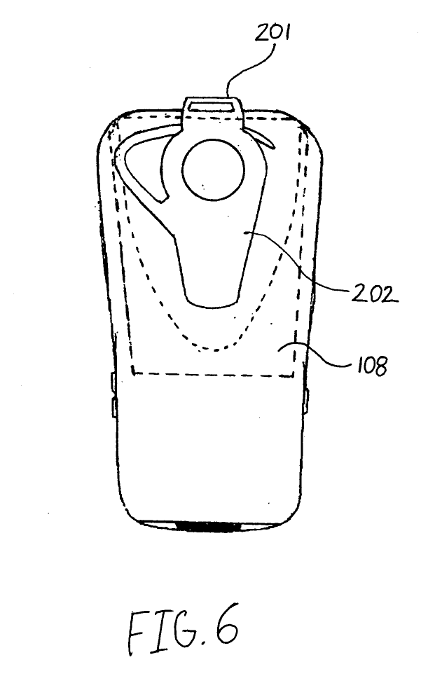

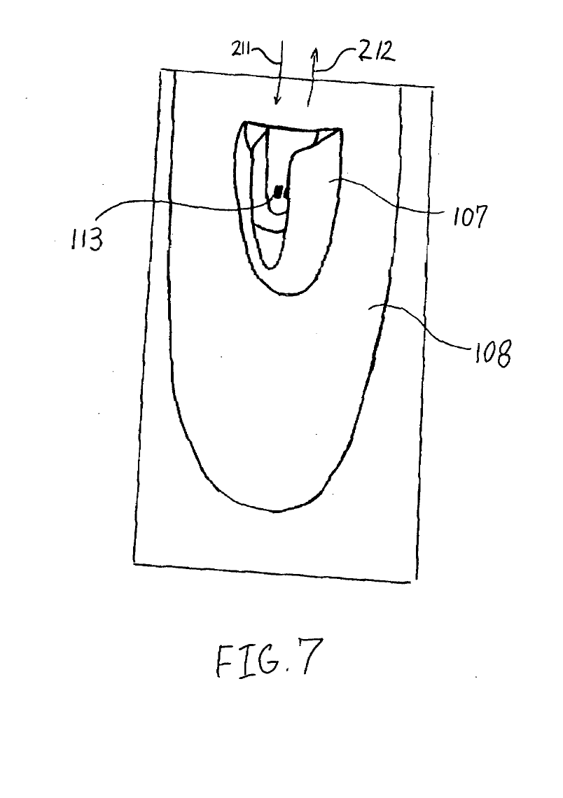

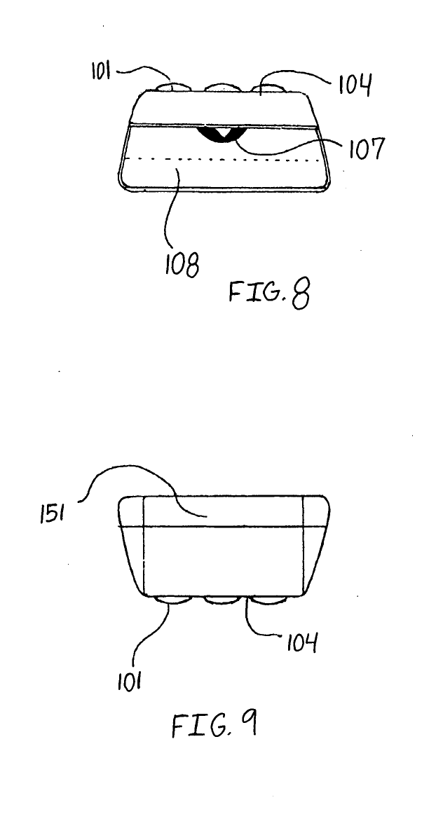

FIG. 4 illustrates the same or similar mobile phone of FIG. 1. Also illustrated is an earpiece 113 attached or docked to the phone charger. Also illustrated are the keypad 101, power connector 102, on/off switch 103 and volume control 106. Additionally, the camera 105 and screen 104 are displayed. FIG. 5 is a side view of the mobile phone showing the placement of the earpiece 202 within the storage compartment 108 and mounted on the earpiece cradle component. Also shown is the earpiece handle 201. FIG. 6 illustrates a rear view of the mobile phone showing the earpiece 202 stored in the storage compartment 108. Also illustrated is a handle like component 201 of the earpiece which facilitates the user removing the earpiece from the cradle component or to push the earpiece into the storage compartment onto the cradle component.

FIG. 7 is a perspective view of rear or back components of the mobile phone. Shown in detail is the cradle component 107 containing the electronic charger connection 113 to recharge the earpiece from the phone battery. The cradle component holds the earpiece. In the embodiment shown, the earpiece is inserted down 211 into the cradle and conversely lifted up 212 and out of the cradle. Also shown is the storage space 108 for holding the earpiece.

FIG. 8 illustrates a top view of an embodiment of the mobile phone. Illustrated is the location of the key pad 101 and LED screen 104, earpiece cradle 107 and charger. Also shown is the storage space 108 which can accommodate multiple types and sizes of earpieces.

FIG. 9 illustrates a bottom 151 of an embodiment of the mobile phone used with the wireless earpiece. Again the location of the front keypad 101 and LED screen 104 is marked.

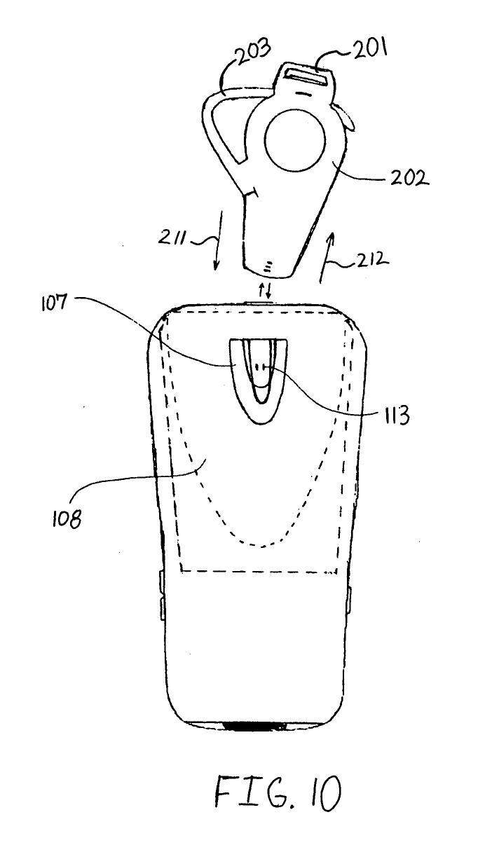

FIG. 10 illustrates the insertion 211 and removal 212 of the wireless earpiece 202 into the storage space 108 and cradle 107 contained in the back of a mobile phone. The cradle is illustrated with electronic components 113 that can place the earpiece in electrical communication with the mobile phone batteries or re-charger, e.g., phone re-charger. Also illustrated is the component 203 of the earpiece that is placed behind the user's ear when in use. The tab holder 201 for removing and inserting is also illustrated.

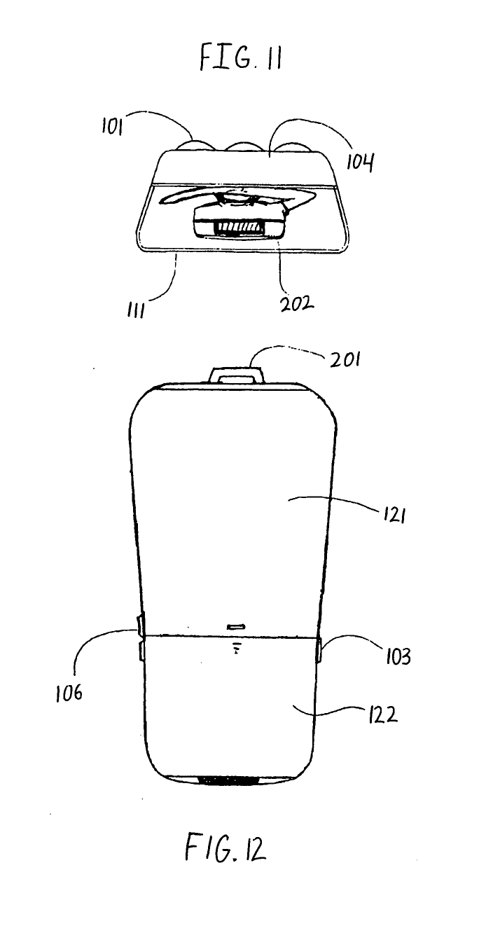

FIG. 11 illustrates a top view of the mobile phone showing the earpiece 202 held in the storage area 111 at the rear of the mobile phone. In this view, the cradle component is not shown. The location of LCD screen 104 and phone key pad 101 is indicated.

FIG. 12 illustrates an embodiment of the mobile phone case wherein the earpiece is stored behind a cover 121 at the rear of the phone. The tab holder of the earpiece 201 is visible. There is a similar cover 122 for the storage of the phone batteries. The location of the mobile phone volume control buttons 106 are marked. Similarly the location of the mobile phone power “on/off” buttons 103 are also marked.

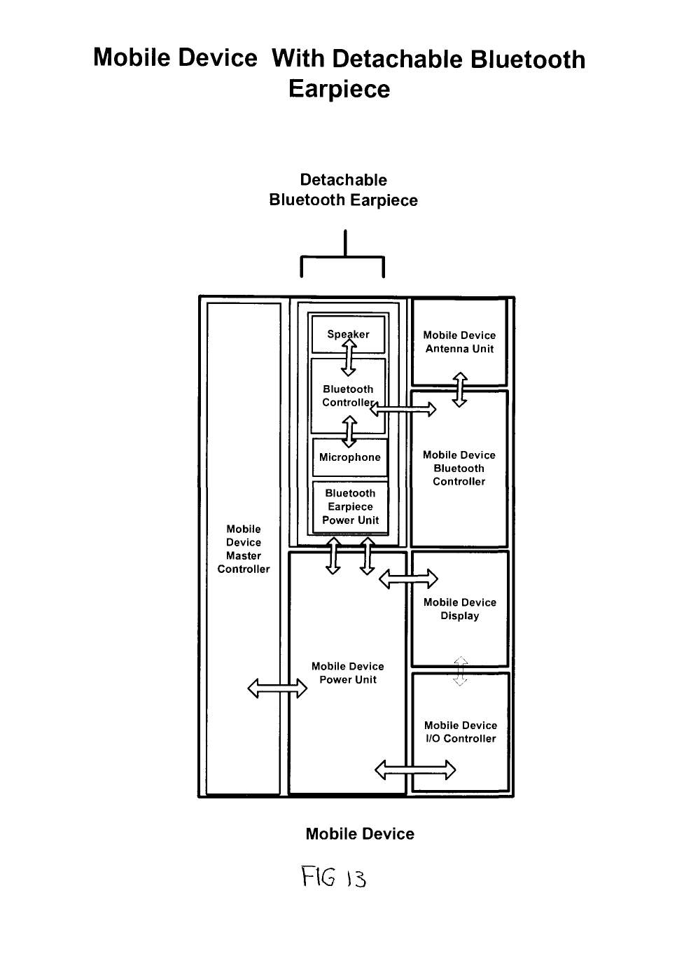

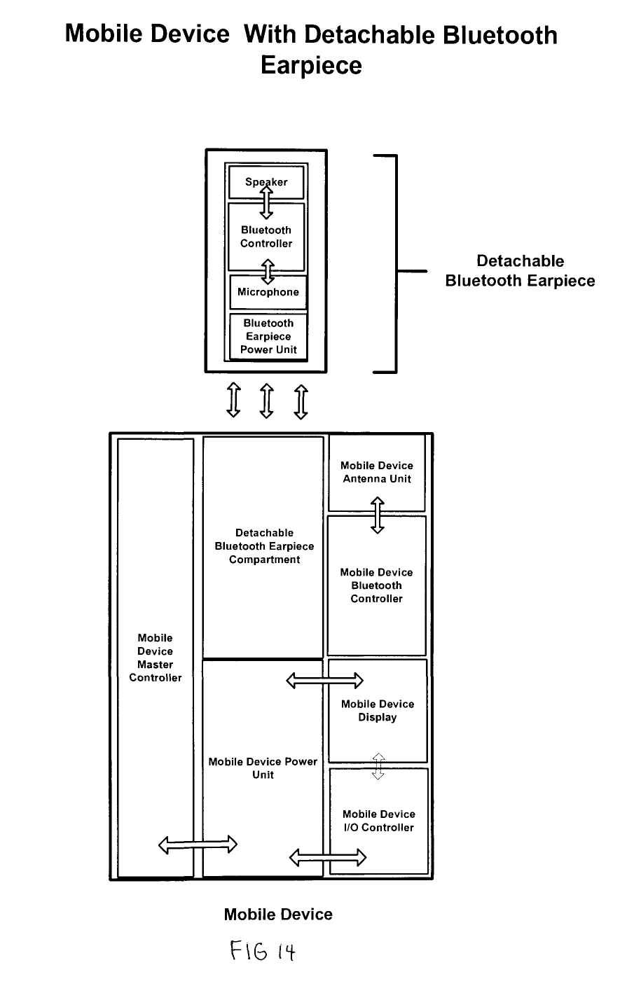

FIG. 13 illustrates an embodiment of the interface between the earpiece 202 and the mobile phone components. The earpiece comprises a speaker, a controller, e.g., Bluetooth controller, a microphone and a power unit, e.g., battery. The components of the mobile phone (mobile device) include a mobile device power unit 170, e.g., battery. FIG. 13 shows the power unit of the mobile phone interconnected with the power unit of the earpiece. Other components of the mobile phone are the mobile phone I/O controller 171, mobile phone display 172, earpiece controller (Bluetooth), mobile phone antenna unit 174 and mobile device master controller 179.

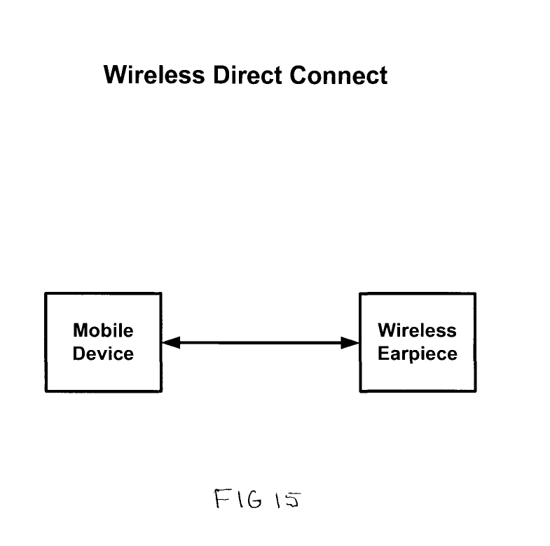

FIG. 14 illustrates the same combination of components but with the earpiece detached from the mobile phone. In the embodiment illustrated in FIGS. 13 and 14, the earpiece is a Bluetooth unit.

FIG. 15 illustrates the earpiece-phone connection. It is a direct connection with no intermediary device. In one embodiment, the mobile phone 170 will be factory paired with a particular wireless earpiece 202 to eliminate the need for pairing these devices by the user. By having them factory designed and programmed, i.e., factory paired, it will assure that the software and hardware are truly compatible and will facilitate the continuous synchronization, recognition and communication between each other.

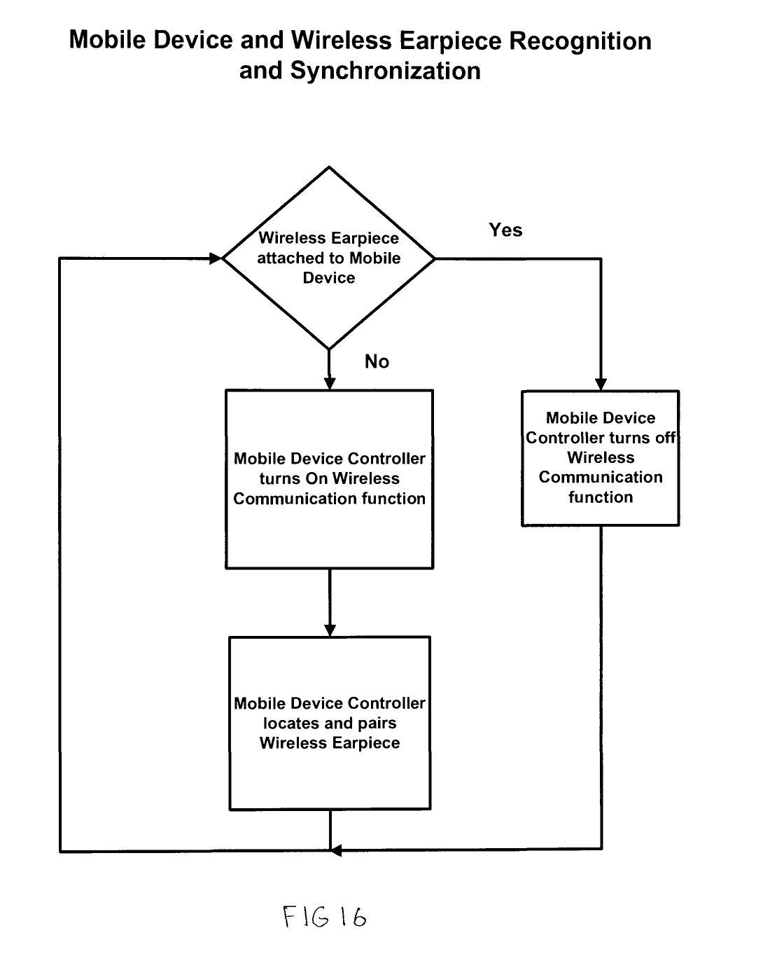

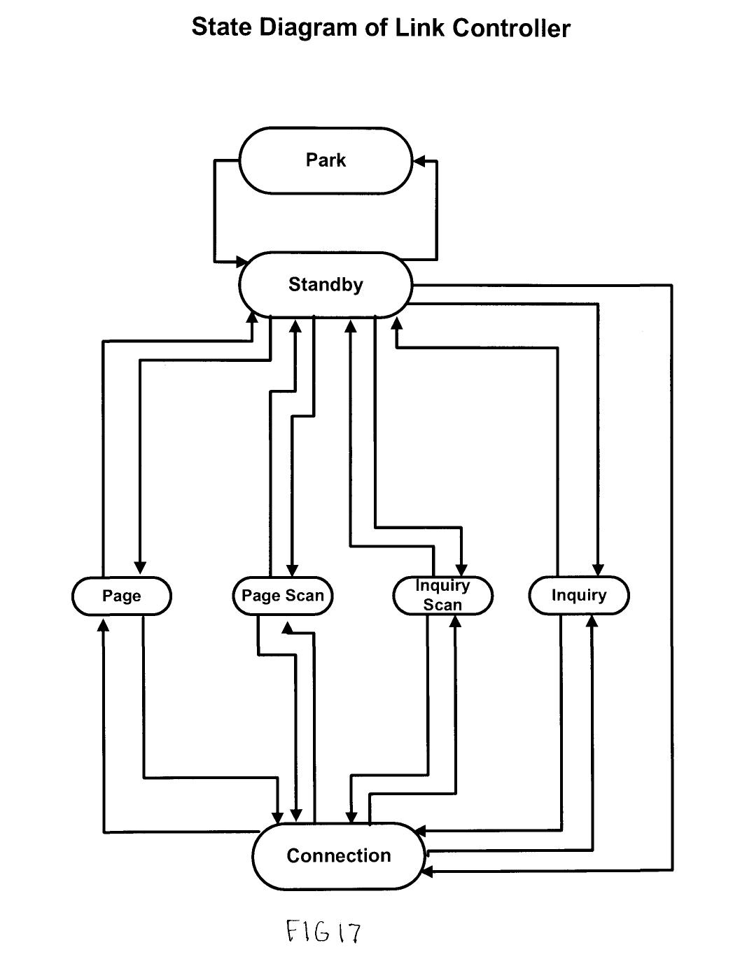

FIG. 16 illustrates the earpiece activation sequence wherein the first step (Step 1) is a determination of whether the earpiece is attached to the mobile device, i.e., mobile phone. In one embodiment, this determination can be made by the absence of electrical contact between the electrical components of the cradle and the earpiece. If not attached, the “mobile device controller” turns on the earpiece (Step 2) and the mobile device controller locates and pairs the wireless earpiece (Step 3). If the wireless earpiece is attached to the mobile device, the mobile device, i.e., mobile phone, turns off the wireless communication function (Step 4).

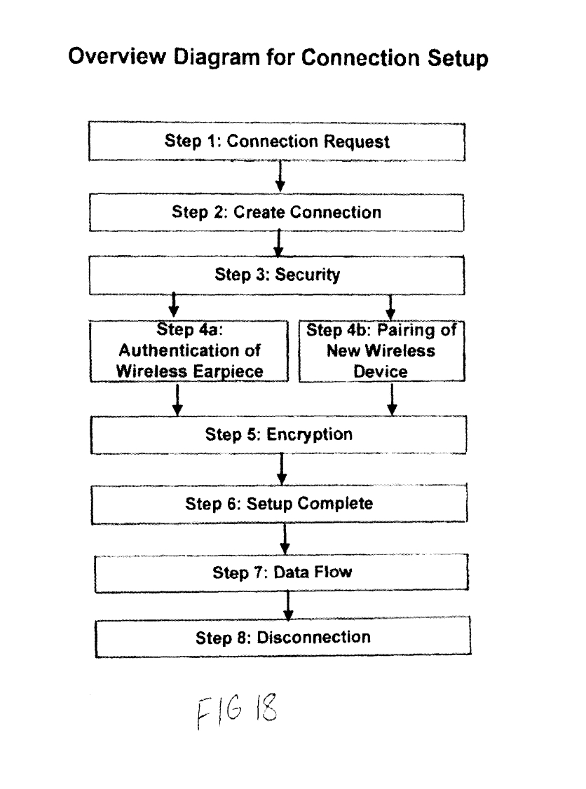

FIG. 17 illustrates the state diagram of the link controller. The diagram illustrates three major states: standby 401, connection 402 and park 403. In addition there are four substates, page 404, page scan 405, inquiry 406 and inquiry scan 407. The substates are interim states that are used to establish the connection and to enable the device discovery between the mobile device and wireless earpiece.

The park state 403 is the default state in the mobile device. In this state, the wireless earpiece is connected to the mobile device. In the park state, the wireless earpiece has little or no communications with the mobile device.

The controller may leave the park state once the wireless earpiece has been detached from the mobile device.

The standby state 401 is the state in which the mobile device and wireless earpiece have been activated by removal of the wireless earpiece from the mobile device and the wireless earpiece is awaiting communications from the mobile phone.

The controller may leave the standby state to scan for page or inquiry messages, or to page or inquiry itself.

In the connection state 402, the signal connection between the mobile device and wireless earpiece has been established and data can be sent back and forth. The connection state starts when the controller identifies the separation of the wireless earpiece from the mobile device, and the mobile device has sent a packet of data to the earpiece. The wireless earpiece will respond by sending a packet back confirming the pairing information.

If the mobile device, e.g., mobile phone, does not receive the response packet for the wireless earpiece, both devices will return to page/page scan 404, 405 substates. The first information packets in the connection state contain control messages that characterize the link and give more details regarding the mobile phone. Then the transfer of user information can start by alternately transmitting and receiving packets.

The connection state is left by returning the wireless earpiece to the attached position or by powering of the unit.

In order to establish new connections the paging procedure is used. Only the wireless earpiece address is required to set up the connection. The mobile device will establish the connection that carries out a page procedure and will automatically become the master of the connection.

In the page scan substate, the mobile device will be configured to use the standard scanning procedure. During a standard scan, the mobile device listens for the match to its device access code. When a mobile device enters the page scan substate, it will select the scan frequency according to the wireless earpiece address pre-programmed to the mobile device.

The page scan substate can be entered from the standby state or the connection state. In the standby state, no connection has been established and the mobile device can use all the capacity to carry out the page scan.

The page substate is used by the mobile device to activate and connect to the wireless earpiece once located in page scan substate. The mobile device tries to coincide with the wireless earpiece scan activity by repeatedly transmitting the paging message consisting of the wireless earpiece access code.

The page substate may be entered from the standby state or the connection state. In the standby state, no connection has been established and the mobile device can use all the capacity to carry out the page. Before entering the page substate from the connection state, the mobile device should free as much capacity as possible for scanning.

The inquiry scan substate is very similar to the page scan substate. However, instead of scanning for the wireless earpiece, the mobile device scans for inquiry access of other devices. The inquiry scan substate can be entered from the standby state or the connection state. In the standby state, no connection has been established and the mobile device can use all the capacity to carry out the inquiry scan. Before entering the inquiry scan substate from the connection state, the mobile device will share capacity for scanning.

The inquiry substate 406 is used by the mobile device to discover new devices. This substate is very similar to the page substate. In between inquiry transmissions, the mobile device will scan for inquiry response messages. When a response is received the mobile device shall continue with inquiry transmissions to establish the identity of the device and to determine a communication path. The inquiry substate can be entered from the standby state or the connection state. In the standby state, no connection has been established and the mobile device can use all the capacity to carry out the inquiry. Before entering the inquiry substate from the connection state, the mobile device will share it's capacity for scanning.

FIG. 18 illustrates an overview of the connection setup. The process is initiated by a connection request, e.g., the earpiece is removed from the mobile phone cradle. A connection is next created followed by security verification. This includes pairing of the phone to the earpiece. This also includes authentication and encryption. At this stage, the connection between the mobile device and earpiece is complete and there is data flow, e.g., conversation. The setup can be disconnected by the earpiece being returned to the storage cradle and electrical contact made with the mobile device power system.

This specification is to be construed as illustrative only and is for the purpose of teaching those skilled in the art the manner of carrying out the invention. It is to be understood that the forms of the invention herein shown and described are to be taken as the presently preferred embodiments. As already stated, various changes may be made in the shape, size and arrangement of components or adjustments made in the steps of the method without departing from the scope of this invention. For example, equivalent elements may be substituted for those illustrated and described herein and certain features of the invention may be utilized independently of the use of other features, all as would be apparent to one skilled in the art after having the benefit of this description of the invention.

Further modifications and alternative embodiments of this invention will be apparent to those skilled in the art in view of this specification.

While specific embodiments have been illustrated and described, numerous modifications are possible without departing from the spirit of the invention, and the scope of protection is only limited by the scope of the accompanying claims.

What we claim are:

1. A mobile phone comprising an earpiece removeably attached to the mobile phone.

2. The mobile phone of claim 1 further comprising a component covering at least a portion of the earpiece.

3. The mobile phone of claim 2 further comprising the cover component being removeable.

4. The mobile phone of claim 3 further comprising activation of the earpiece or mobile phone by removal of the cover component.

5. The mobile phone of claim 1 further comprising activation of the earpiece or mobile phone by removal of the earpiece from the mobile phone.

6. The mobile phone of claim 1 further comprising a removeable storage cover.

7. The mobile phone of claim 1 further comprising a holder component including electronic charger connections.

8. The mobile phone of claim 1 further comprising a storage space dimensioned to hold earpieces of different sizes.

9. A earpiece stored and activated with a mobile phone comprising:
a) an earpiece fitting to a holder component of a mobile phone;
(b) electrical components establishing electrical communication between the mobile phone and the stored earpiece for charging the earpiece;
c) a switch mechanism activated by removal of the earpiece from the mobile phone holder component;
(d) activation of the earpiece by the activation of the switch; and
(e) deactivation of the earpiece by returning the device to a holder component.

10. The earpiece of claim 9 further comprising placing the earpiece in the holder component and simultaneously charging of the mobile phone.

11. The earpiece of claim 9 further comprising the earpiece being received into a snap holder of the mobile phone housing.

12. A mobile phone adaptable for use with a earpiece comprising the storage of the earpiece with the phone.

13. The mobile phone of claim 12 further comprising a holder component for the earpiece.

14. A method for activation and pairing of an earpiece and mobile phone comprising the steps:
(a) determining the earpiece is not connected to the mobile phone;
(b) activating the earpiece; and
(c) pairing the mobile phone with the earpiece.

15. The method of claim 14 further comprising determining the earpiece is not connected to the mobile phone by a break in an electrical circuit.

16. The method of claim 15 further comprising a break in the electrical circuit at the holder component.
